(19) United States
(12) Patent Application Publication
(10) Pub. No.: US 2018/0147802 A1
(43) Pub. Date: May 31, 2018

(54) Flash-Free Mold Assembly

(71) Applicant: NIKE, INC., Beaverton, OR (US)

(72) Inventor: Jose ISSE, Beaverton, OR (US)

(21) Appl. No.: 15/572,869

(22) PCT Filed: May 13, 2016
(86) PCT No.: PCT/US2016/032413

§ 371 Date: Nov. 9, 2017

Related U.S. Application Data
(60) Provisional application No. 62/160,747, filed on May 13, 2015.

(51) Int. Cl. B29D 35/00; B29D 35/12; A43B 13/14

(52) U.S. Cl. CPC B29D 35/009; B29D 35/122; B29K 2905/10; B29K 2905/12; B29K 2905/02; A43B 13/14

(57) ABSTRACT

A flash-free mold assembly (100) is provided. The mold assembly comprises a first plate (110) and a second plate (112) adapted to be superimposed on the first plate to define a mold space therein. The first plate comprises one or more projections (120, 122) surrounding the mold space, and the second plate is adapted to be superimposed on the first plate such that it primarily contacts the one or more projections of the first plate.

### FIELD OF THE INVENTION

The aspects hereof relate to a mold assembly for use in the manufacture of a molded article of footwear that is free of flash. More particularly, the aspects relate to a mold assembly having a first plate and a second plate shaped to define a mold space therein. The first plate has at least one or more projections surrounding the mold space. When the first plate and the second plate are in an operative relationship, the second plate is adapted to primarily contact the projections of the first plate.

### BACKGROUND OF THE INVENTION

Typical mold assemblies used in the manufacture of an article of footwear generally are configured such that when the mold plates are in an operative relationship, the plate surfaces are in complete or substantial contact with each other excepting those portions of the plates that define the mold space. These types of mold assemblies typically produce flash or flashing on the molded article at the intersection of the mold plates because there is nothing preventing the egress of the moldable compound from the mold space during the molding process. For instance, when forming a shoe sole portion using a typical mold assembly, flash is generally formed on the side surface of the shoe sole portion where the top plate of the mold assembly meets the bottom plate of the assembly. The flash must eventually be removed by cutting, breaking, grinding, and the like. Removal of the flashing is usually a manual process that not only slows down production times but increases manufacturing costs. Moreover, it has been estimated that as much as 10-20% of the moldable compound is lost as flash which further contributes to high manufacturing costs associated with articles of footwear. Even after removal of the flash, a demarcation line typically remains on the side surface of the shoe sole portion indicating where the flash was removed and, by extension, where the mold plates intersected. In other words, typical mold assemblies prevent a continuous or sealed skin from being formed on the molded article at the intersection of the mold plates.

Further, because the area of contact between the mold plates is so large, these types of mold assemblies require a high amount of force to be applied to the mold assembly by a mold press in order to generate the necessary pressure to cure the moldable compound. When high amounts of force are consistently applied to the mold assembly, the life of the mold assembly is reduced which also increases manufacturing costs as the mold assembly must be replaced. Moreover, because of the high amount of force applied to the mold assembly, the mold assembly must generally be constructed entirely of harder, less deforming metals such as steel versus softer, more deforming metals such as bronze or aluminum in order to prolong the life of the mold assembly. Because of this, the mold assembly may weigh and/or cost more than if the mold assembly were constructed of other types of metals such as, for example, aluminum or bronze in place of some of the steel components. This may pose additional hurdles and/or costs to the manufacturing process when, for example, the mold assembly needs to be moved and/or replaced. Constructing a mold assembly that eliminates the generation of flashing, and is lightweight but yet durable has been challenging.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects generally relate to a mold assembly having a first plate and a second plate that is operatively coupled to the first plate. The first plate may be shaped to define at least a portion of a mold space. Additionally, the first plate may comprise a plate surface and one or more projections that extend upward from the plate surface and surround the portion of the mold space. In turn, the plate surface surrounds the one or more projections.

The second plate is adapted to be superimposed on the first plate and, when superimposed, further defines the mold space therein. When superimposed on the first plate, the second plate is adapted to primarily contact the one or more projections surrounding the portion of the mold space. The second plate may comprise one or more vent apertures that are in communication with the mold space when the second plate is superimposed on the first plate. The vent apertures allow excess moldable compound to escape from the mold cavity.

Using the configuration described, flashing may be eliminated from the molded article of footwear at the intersection of the first plate and the second plate of the mold assembly. Using a shoe sole portion such as a midsole, an outsole, or a midsole/outsole combination as an example of a molded article of footwear, the mold assembly described herein is adapted to generate a continuous or sealed skin along the side surface of the shoe sole portion thereby improving the aesthetic appearance and structural integrity of the shoe sole portion as well as eliminating the need to remove flashing produced by the molding process.

Moreover, by limiting the area of contact between the first plate and the second plate to generally that of the projections on the first plate, a greater amount of pressure can be generated in response to the application of a fixed force by a mold press to the mold assembly. This is based on the formula, Force/Area=Pressure. By extension, by limiting the area of contact between the first and second plates to that of the projections, the force that is applied to the mold assembly by the mold press can be reduced or lessened while still generating the amount of pressure needed to cure the moldable compound. A result of applying less force to the mold assembly is an increased lifespan of the mold assembly and the ability to construct the mold assembly in part from different types of softer metals such as bronze or aluminum as opposed to constructing the mold assembly entirely of harder metals such as steel.

Aspects additionally relate to a molded article of footwear molded using the molding assembly described above. The molded article of footwear may comprise a top surface, a bottom surface, and a side surface. The side surface may have a continuous or sealed skin at the intersection of the first plate and the second plate of the mold assembly.

Aspects further relate to methods of molding an article of footwear using the mold assembly described above. A fixed quantity of moldable compound is provided, and the article of footwear is molded using the mold assembly described herein, where the article of footwear comprises a top surface, a bottom surface, and a side surface having a continuous or sealed skin at the intersection of the first plate and the second plate of the mold assembly. The method may further comprise determining an amount of pressure needed to cure the moldable compound, determining the area of contact between the first plate and the second plate of the mold assembly, and determining a force to be applied by a mold press to the mold assembly based on the determined amount of pressure and the determined area of contact between the first and second plates. The determined amount of force is applied to the mold assembly for a predetermined period of time to form the article of footwear.

### BRIEF DESCRIPTION OF THE DRAWING

The present invention is described in detail below with reference to the attached drawing figures, wherein:

FIG. 1 illustrates a front perspective view of an exemplary mold assembly for reference purposes in accordance with aspects hereof;

FIG. 2 illustrates a cross-sectional view of a first plate of the exemplary mold assembly taken along cut line 2-2 of FIG. 1 for reference purposes in accordance with aspects hereof;

FIG. 3 illustrates a cross-sectional view of a second plate of the exemplary mold assembly taken along cut line 3-3 of FIG. 1 for reference purposes in accordance with aspects hereof;

FIGS. 4A and 4B illustrate cross-sectional views of the first plate of the exemplary mold assembly taken along cut lines 4A-4A and 4B-4B respectively of FIG. 1 for reference purposes in accordance with aspects hereof;

FIGS. 5A and 5B illustrate cross-sectional views of the second plate of the exemplary mold assembly taken along cut lines 5A-5A and 5B-5B respectively of FIG. 1 for reference purposes in accordance with aspects hereof;

FIG. 6 illustrates a cross-sectional view of the exemplary mold assembly and the formation of a mold space between the first plate and the second plate of the mold assembly and further illustrates a relationship between the first plate and the second plate of the mold assembly when a force is being applied to the mold assembly by a mold press for reference purposes in accordance with aspects hereof;

FIG. 7 illustrates a close-up view at the area indicated on FIG. 6 for reference purposes in accordance with aspects hereof;

FIG. 8A illustrates a cross-sectional view of the exemplary mold assembly taken along a rear portion of the assembly and further illustrates a relationship between the first plate and the second plate of the mold assembly when a force is being applied to the mold assembly by a mold press for reference purposes in accordance with aspects hereof;

FIG. 8B illustrates a cross-sectional view of the exemplary mold assembly taken along a front portion of the assembly and further illustrates a relationship between the first plate and the second plate of the mold assembly when a force is being applied to the mold assembly by the mold press for reference purposes in accordance with aspects hereof;

FIG. 9 illustrates an exemplary flow diagram of a method of making a molded article of footwear using the exemplary mold assembly for reference purposes in accordance with aspects hereof;

FIG. 10A illustrates a side perspective view of an exemplary molded article of footwear for references purposes in accordance with aspects hereof;

FIG. 10B illustrates a close-up view of the area indicated in FIG. 10A for reference purposes in accordance with aspects hereof;

FIG. 11 illustrates a cross-sectional view of an exemplary mold assembly and an exemplary mold press for reference purposes in accordance with aspects hereof; and

FIG. 12 illustrates an exemplary flow diagram of a method of making a molded article of footwear using the exemplary mold assembly for reference purposes in accordance with aspects hereof.

### DETAILED DESCRIPTION OF THE INVENTION

Aspects provide for a flash-free mold assembly for use in the manufacture of an article of footwear such as, for example, a midsole, an outsole, a combination midsole/outsole, and/or portions thereof. Such articles of footwear are generally formed by filling or injecting a mold space of a mold assembly with a moldable compound or mixture and generating a pressure needed to cure the moldable compound by utilizing a mold press to apply a predefined force to the mold assembly. The moldable compound may comprise natural or man-made materials such as rubber, polyurethane, thermoplastic polyurethane (TPU), ethylene vinyl acetate (EVA), other types of foams, and the like. As discussed above, typical molding techniques often create flash or flashing on the molded article at the intersection of the mold plates. As used throughout this disclosure, the term “flash” or “flashing” means excess material that is attached to a molded product and which usually must be removed in a post-processing step. The mold assembly described herein eliminates flash and produces a continuous or sealed skin on the molded article of footwear at the intersection of the plates of the mold assembly. The mold assembly described herein, moreover, is configured such that the amount of force that needs to be applied to the mold assembly by a mold press in order to generate the requisite amount of pressure needed to cure the moldable compound is reduced.

The exemplary mold assembly described herein may comprise a first plate having at least one mold cavity and a second plate that is operably coupled to the first plate. When superimposed over the mold cavity of the first plate, the first and second plates may define a mold space. The first plate may comprise one or more projections extending upward from the plate surface of the first plate and circumscribing or encircling the mold cavity. The plate surface, in turn, may completely surround the one or more projections. In an exemplary aspect, the first plate may further comprise one or more depressions extending downward from the plate surface and located at, for example, the corners of the first plate and/or along a front portion of the first plate.

In an exemplary aspect, the second plate may comprise one or more depressions adapted to receive the one or more projections of the first plate when the second plate is in an operative relationship with the first plate (i.e., when the second plate is superimposed on the first plate). Further, when the second plate is superimposed on the first plate, the second plate may be adapted to primarily contact the one or more projections of the first plate. In some exemplary aspects, the second plate may be adapted to only contact the one or more projections of the first plate. The second plate may also comprise one or more vent apertures that are in communication with the mold space when the second plate is superimposed on the first plate. The second plate may optionally comprise one or more projections extending upward from the surface of the second plate and adapted to be received into the one or more depressions of the first plate when the second plate is superimposed on the first plate.

The configuration thus described helps to eliminate the formation of flash on the article of footwear at the intersection of the first and second plates when the mold space is filled/injected with a moldable compound and force is applied to the mold assembly by a mold press to form the article of footwear. Further, by generally limiting the area of contact between the first plate and the second plate to that of the projections on the first plate, a greater amount of pressure may be generated in response to a fixed force being applied to the mold assembly by the mold press. One result of this is that the amount of force applied to the mold assembly by the mold press can be reduced while still generating the pressure needed to cure the moldable composition. By decreasing the amount of force applied by the mold press, the lifespan of both the mold assembly and the mold press may be prolonged. As well, because a decreased amount of force is being applied to the mold assembly, the mold assembly may be constructed in part from softer, more-deforming metals such as aluminum and/or bronze which may help to reduce the costs associated with making the mold assembly along with possibly reducing the weight of the mold assembly.

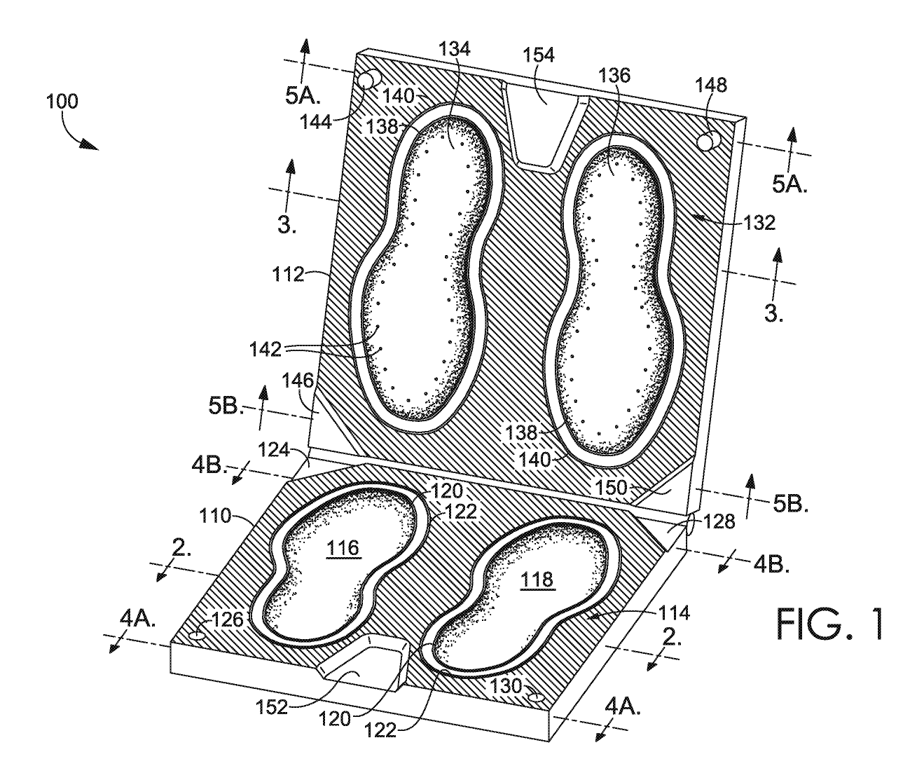

Turning now to FIG. 1, an exemplary front perspective view of a mold assembly 100 in an open position is illustrated in accordance with aspects provided herein. The mold assembly 100 may generally comprise a first plate 110 and a second 112 operatively coupled to the first plate 110. The operative coupling between the first plate 110 and the second plate 112 may comprise, for example, a pivot-type connection located at a rear area of the plates 110/112 that enables the second plate 112 to pivot from the open position to a closed position and vice versa such as, for example, a knuckle-and-pin hinge. In another aspect, the second plate 112 may not be physically coupled to the first plate 110 but, instead, may be lowered onto or brought into contact with the first plate 110 when the mold assembly 100 is used to mold a moldable compound. Any and all such aspects, and any variation thereof, are contemplated as being within the scope herein.

The first plate 110 may have a generally square or rectangular shape and be constructed from materials having a high degree of hardness such as, for example, steel or ceramics. The term “hardness” as used herein means a measure of how resistant solid matter is to various kinds of shape changes when a compressive force is applied. The first plate 110 may comprise a plate surface 114 (indicated by the hash marks), one or more mold cavities 116 and 118, a first projection 120, and a second projection 122. The first plate 110 may optionally further comprise pin receiving holes 126 and 130, corner depressions 124 and 128, and a midline depression 152 located at a front edge of the first plate 110 and situated between the mold cavity 116 and the mold cavity 118.

The mold cavities 116 and 118 may comprise depressions extending downward from the plate surface 114 into the body of the first plate 110. In an exemplary aspect, the mold cavities 116 and 118 may be shaped so as to mold a midsole, an outsole, a combination midsole/outsole, and/or portions thereof. As such, the mold cavities 116 and 118 may be in the general shape of these articles of footwear. Further, the mold cavities 116 and 118, in an exemplary aspect, may comprise a mold cavity for an article of footwear configured for a right foot (e.g., mold cavity 118) and an article of footwear configured for a left foot (e.g., mold cavity 116). The mold cavities 116 and 118 may be sized for a particular shoe size. In other exemplary aspects, the first plate 110 may comprise a single mold cavity or multiple mold cavities which may be used to mold other articles of footwear such as inserts, heel cups, and the like. Any and all such aspects, and any variation thereof, are contemplated as being within the scope herein.

The first projection 120 may extend generally perpendicularly upward from the plate surface 114 when the mold assembly 100 is in an as-used configuration. Using the mold cavity 116 as a representative example, the first projection 120 may circumscribe the mold cavity 116 and be in the same general shape configuration as the mold cavity 116. To put it another way, the first projection 120 may form a continuous ridge surrounding and partially contiguous with the mold cavity 116.

Likewise, the second projection 122 may be spaced apart from the first projection 120 and extend generally perpendicularly upward from the plate surface 114. The second projection 122 may circumscribe the first projection 120 and it also may circumscribe the mold cavity 116. To put it another way, the second projection 122 may form a continuous ridge surrounding both the first projection 120 and the mold cavity 116 and be in the same general shape configuration as the first projection 120 and the mold cavity 116. In turn, as illustrated in FIG. 1, the plate surface 114 completely surrounds (i.e., without disruptions) the projections 120 and 122.

The use of two projections, as opposed to just one projection, may help to disperse the force transmitted by the mold press to the mold assembly 100 when the second plate 112 is superimposed on the first plate 110 such that the second plate 112 contacts the projections 120 and 122. This, in turn, helps to prevent excess wear-and-tear on the projections 120 and 122 and may prolong the lifespan of the mold assembly 100. Although two projections are shown in FIG. 1, it is contemplated that the mold assembly 100 may comprise just one projection or may comprise more than two projections. The number of projections surrounding the mold cavities 116 and 118 may be dependent on factors such as the amount of force that is to be applied by a mold press to the mold assembly 100, the materials used to construct the mold assembly 100, the area of contact between the first plate 110 and the second plate 112 when the second plate 112 is superimposed on the first plate 110, and the like.

As mentioned, the first plate 110 may also comprise pin receiving holes 126 and 130 located at the front corners of the first plate 110. The pin receiving holes 126 and 130 are adapted to receive pins 144 and 148 located on the second plate 112 when the second plate 112 is superimposed on the first plate 110. More specifically, the pin receiving hole 126 is adapted to receive the pin 144 and the pin receiving hole 130 is adapted to receive the pin 148. This helps to secure and align the plates 110/112 together and prevent movement between the plates 110/112 during the molding process.

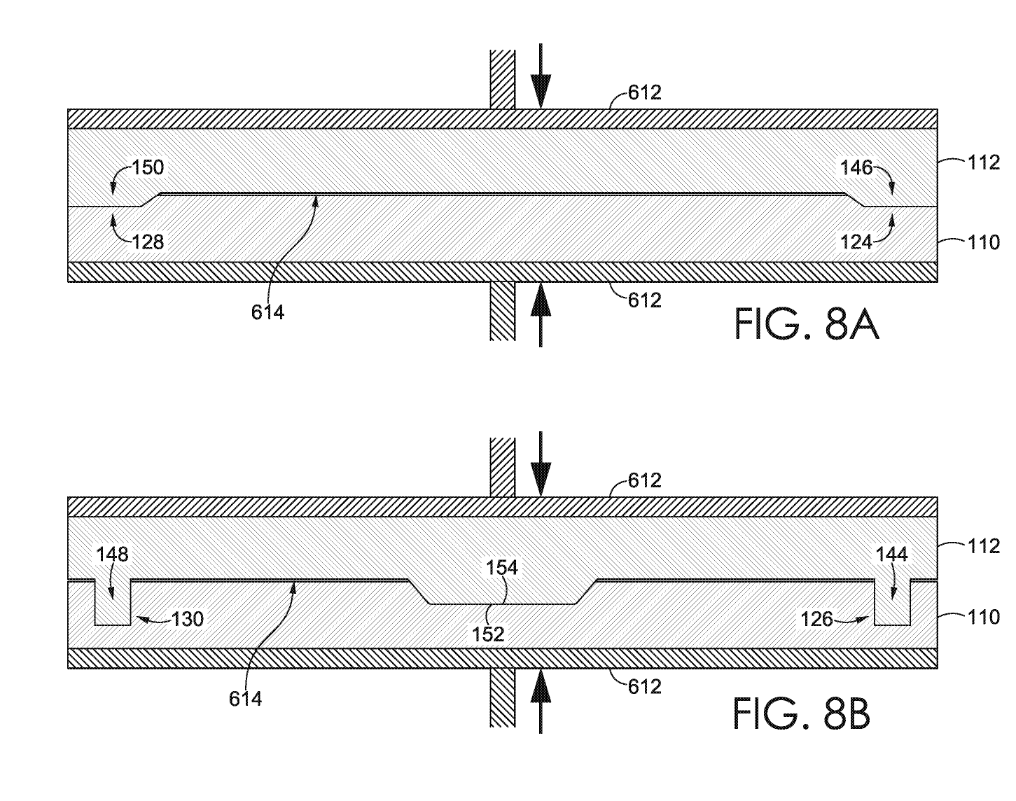

The first plate 110 may further comprise the triangular-shaped depressions 124 and 128 located at the two rear corners of the first plate 110 and extending downward from the plate surface 114 into the body of the first plate 110. In an exemplary aspect, the depressions 124 and 128 may be adapted to receive corresponding triangular-shaped projections located on the second plate 112. This aspect is shown in more detail with respect to FIG. 8A. Although the depressions 124 and 128 are depicted in a triangular-shape, it is contemplated that the depressions 124 and 128 may have different shapes such as, for example, a square, a rectangle, a circle, and the like.

As well, the first plate 110 may comprise the midline depression 152. In aspects, the midline depression 152 extends downward from the plate surface 114 into the body of the first plate 110 and may be located along a front portion of the first plate 110 at a position midway between the mold cavities 116 and 118. The midline depression 152 may be generally triangular shaped with the base of the triangle intersecting the front edge of the first plate 110 and the “apex” of the triangle extending towards the center of the first plate 110. In aspects, the “apex” may not comprise a true pointed apex but, instead, be more rounded or squared-off as shown in FIG. 1. The sides of the midline depression 152 may be angled inward toward each other from the plate surface 114 to the bottom of the depression 152 thereby forming a beveled edge. The midline depression 152 may be adapted to receive a corresponding projection located on the second plate 112 to further align and secure the plates during the molding process. This will be explained in greater depth with respect to FIG. 8B.

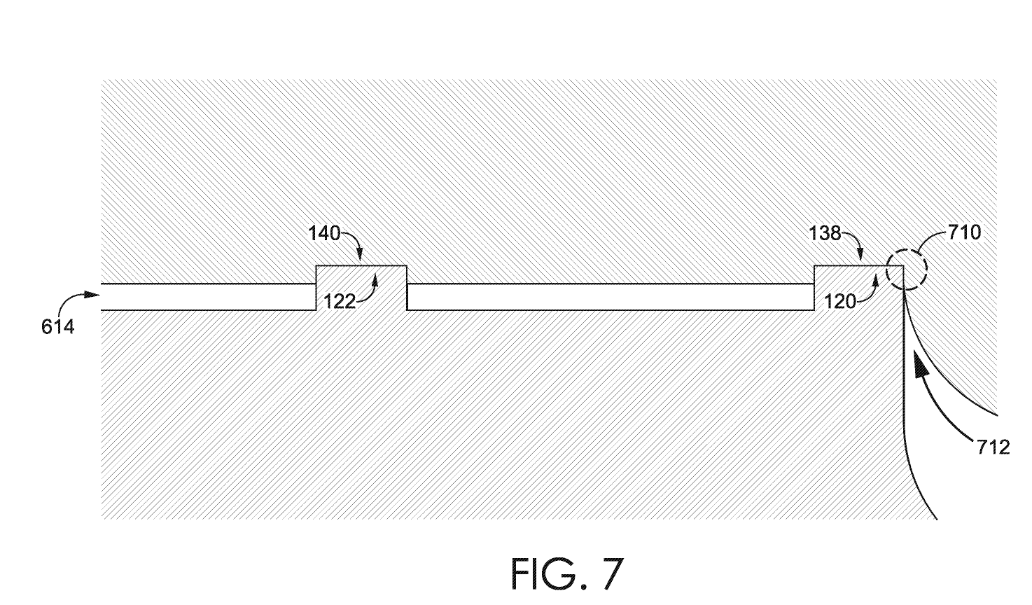

The second plate 112 may also have a generally square or rectangular shape that is substantially congruent with the shape of the first plate 110. The second plate 112 may be constructed from materials similar to the first plate 110 such as, for example, steel or ceramic. Alternatively, the second plate 112 may be constructed, in total or in part, of materials, such as bronze, aluminum, or alloys of each, that deform to a greater degree than the materials used to construct the first plate 110 in response to the application of force. Any and all such aspects, and any variation thereof, are contemplated as being within the scope herein. The benefits of using these types of metals will be explained in greater depth below with respect to FIG. 7. The second plate 112 may comprise a plate surface 132 (indicated by hash marks), one or more mold surfaces 134 and 136, and a plurality of vent apertures 142. The second plate 112 may further optionally comprise a first depression 138, a second depression 140, a first pin 144, a second pin 148, two triangular-shaped projections 146 and 150, and a midline projection 154.

The mold surfaces 134 and 136 of the second plate 112 are complementary to the mold cavities 116 and 118 of the first plate 110. When the second plate 112 is superimposed on the first plate 110, the mold surface 134 in combination with the mold cavity 116 form a first complete mold space for an article of footwear (i.e., an article of footwear configured for a left foot). Likewise, the mold surface 136 in combination with the mold cavity 118 of the first plate 110 form a second complete mold space for an article of footwear (i.e., an article of footwear configured for a right foot). As explained above, the article of footwear may comprise a midsole, an outsole, a combination midsole/outsole, portions of a midsole and/or outsole, inserts, heel cups, and the like.

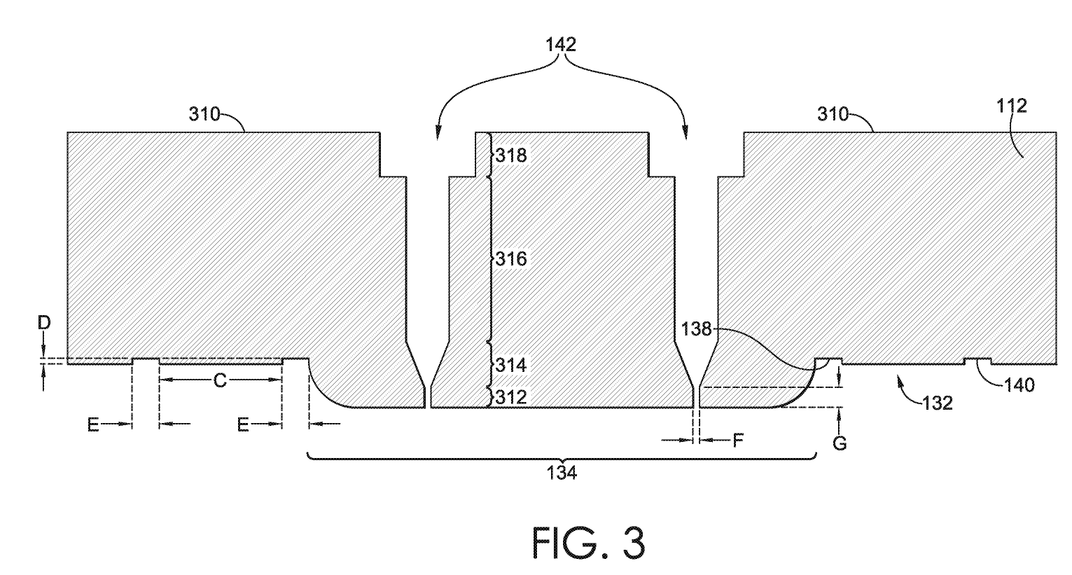

The mold surfaces 134 and 136 may each comprise the plurality of vent apertures 142 that extend from the mold surfaces 134 and 136 to an exterior surface of the second plate 112 (not shown in FIG. 1). The vent apertures 142 may provide a conduit or passageway from the interior of the mold space to the external environment when the mold assembly 100 is being used. The vent apertures 142 may be used not only to vent steam/gases produced by the curing process but also to provide a passageway for excess moldable compound to exit the mold spaces. For instance, in a typical molding process, the mold spaces may be filled with an excess amount of the moldable compound (e.g., an amount of moldable compound that is greater than that needed in the finished article of footwear). “Overfilling” the mold spaces may help to increase the internal pressure within the mold space which, in turn, may allow the moldable compound to copy all the details of the mold space, and/or may further reduce curing times. The excess moldable compound can escape the mold spaces via the vent apertures 142. After a certain number of uses, the vent apertures 142 may be cleaned. A more detailed view of the vent apertures 142 will be provided below with respect to FIG. 3.

The first and second depressions 138 and 140 of the second plate 112 may be complementary to the first and second projections 120 and 122 of the first plate 110. As such, the first depression 138 may comprise a recess or groove on the plate surface 132 and may be adapted to receive the first projection 120 of the first plate 110 when the mold assembly 100 is in an as-used configuration. Using the mold surface 134 as a representative example, the first depression 138 may circumscribe the mold surface 134 and have the same general shape configuration as the mold surface 134. In other words, the first depression 138 may form a continuous depression surrounding the mold surface 134 and partially contiguous with the mold surface 134. Likewise, the second depression 140 may be spaced apart from the first depression 138 and may also comprise a recess or groove on the plate surface 132. The second depression 140 may be adapted to receive the second projection 122 of the first plate 110 when the mold assembly 100 is in an as-used configuration. The second depression 140 may circumscribe the first depression 138 and it may also circumscribe the mold surface 134. To put it another way, the second depression 140 may form a continuous depression surrounding both the first depression 138 and the mold surface 134 and have the same general shape configuration as the first depression 138 and the mold surface 134. In turn, the plate surface 132 completely surrounds (i.e., without disruptions) both the first and second depressions 138 and 140. Although two depressions are shown in FIG. 1, it is contemplated that the mold assembly 100 may comprise just one depression or may comprise more than two depressions. The number of depressions surrounding the mold surfaces 134 and 136 may be dependent on the number of projections on the first plate 110.

The pin 144 and the pin 148 may be located at the two front corners of the second plate 112 and may extend perpendicularly out from the plate surface 132. The pins 144 and 148 are adapted to be received into the pin receiving holes 126 and 130 of the first plate 110 when the second plate 112 is superimposed on the first plate 110. This configuration helps to secure the plates 110 and 112 together and prevent movement of the plates 110 and 112 when a force is applied to the mold assembly 100.

The triangular-shaped projections 146 and 150 extend out from the plate surface 132 and are generally located at the two rear corners of the second plate 112. As explained above, the projections 146 and 150 are adapted to be received into the depressions 124 and 128 when the second plate 112 is superimposed on the first plate 110. Although a triangular shape is shown for the projections 146 and 150, it is contemplated that the projections 146 and 150 may have different shapes such as a square, a rectangle, a circle, and the like. The shape of the projections 146 and 150 of the second plate 112 should generally correspond to the shape of the depressions 124 and 128 of the first plate 110.

The midline projection 154 extends out from the plate surface 132 and is generally located along a front portion of the second plate 112. The midline projection 154 may have a shape corresponding to the midline depression 152 of the first plate 110. As such, the projection 154 may be generally triangular-shaped with the base of the projection 154 being aligned with the front edge of the second plate 112 and the “apex” of the projection 154 extending towards the center of the plate 112. As with the midline depression 152, the “apex” may be rounded or squared-off as shown in FIG. 1. The sides of the projection 154 generally angle inward from the plate surface 132 to the top of the projection 154 to form a beveled edge. Although this is one type of configuration, other configurations of the projection 154 are contemplated herein.

The relationship between the triangular-shaped depressions 124 and 128 of the first plate 110 and the corresponding projections 146 and 150 of the second plate 112 along with the midline depression 152 of the first plate 110 and the midline projection 154 of the second plate 112 helps to align the first and second plates 110 and 112 when the second plate 112 is superimposed on the first plate 110. Having the plates 110 and 112 properly aligned prior to a mold press applying force to the mold assembly 100 helps to prevent the force from being unevenly applied to the projections 120 and/or 122 which could potentially cause permanent deformation of these structures.

In an optional aspect, the relationship between these depressions and projections, moreover, may help to slightly increase the area of contact between the first plate 110 and the second plate 112 when the second plate 112 is superimposed on the first plate 110. By slightly increasing the area of contact between the first and second plates 110 and 112, the force applied by the mold press to the mold assembly 100 may be more dispersed instead of being limited only to the projections 120 and/or 122 thereby prolonging the life of the projections 120 and 122. The depressions 124, 128 and 152 of the first plate 110 and the projections 146, 150, and 154 of the second plate 112 may be optional in certain situations. For example, if the mold assembly 100 comprises only one mold space, these depressions/projections may not be present. This also may hold true if the mold press is configured such that it is consistently centered on the mold assembly 100 and consistently applies a uniform force to the projections 120 and 122.

Thus, when the mold assembly 100 is in an as-used configuration (e.g., when the second plate 112 is superimposed on the first plate 110), the areas of contact between the first plate 110 and the second plate 112 may generally comprise: 1) the first projections 120 and the first depressions 138; 2) the second projections 122 and the second depressions 140; and, optionally 3) the pins 144 and 148 and the pin receiving holes 126 and 130 respectively; 4) the triangular-shaped projections 146 and 150 and the corresponding triangular-shaped depressions 124 and 128; and/or 5) the midline projection 154 and the midline depression 152. When the mold assembly 100 is in an as-used configuration, the plate surface 114 of the first plate 110 generally does not come into contact with the plate surface 132 of the second plate 112.

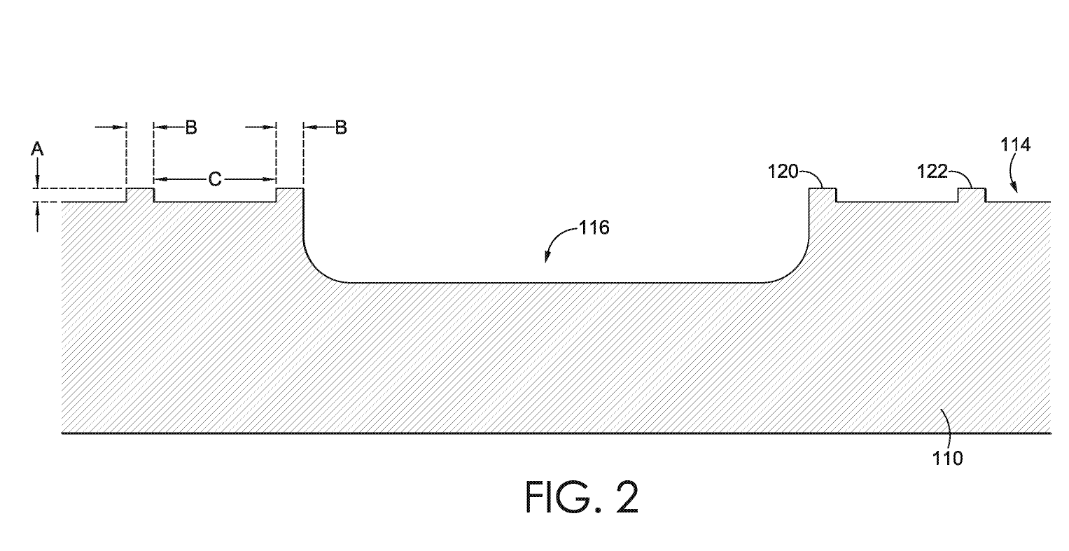

Turning now to FIG. 2, an exemplary cross-sectional view of the first plate 110 is illustrated taken along cut line 2-2 of FIG. 1 in accordance with aspects provided herein. FIG. 2 is limited to that portion of the first plate 110 containing the mold cavity 116. Although FIG. 2 illustrates just the portion of the first plate 110 containing the mold cavity 116, the following disclosure is equally applicable to the portion of the first plate 110 containing the mold cavity 118.

As seen in FIG. 2, the first projection 120 extends perpendicularly upward from the plate surface 114 by a height “A.” Part of the first projection 120 may comprise an extension of the wall that forms the mold cavity 116. In exemplary aspects, the height A may be between 0.5 millimeter (mm) and 1.5 mm, between 0.8 mm and 1 3 mm, and/or between 0.9 mm and 1.1 mm. The first projection 120 may have a flat surface or top that has a width “B.” In exemplary aspects, the width B may be between 1.0 mm and 3.0 mm, between 1.5 mm and 2.5 mm, and/or between 1.9 mm and 2.1 mm.

The second projection 122 may be offset or spaced apart from the first projection 120 by a distance “C.” In exemplary aspects, the distance C may be between 12 mm and 14 mm, between 11 mm and 13 mm, and/or between 10 mm and 12 mm. The second projection 122 may be contiguous with and extend perpendicularly upward from the plate surface 114 by a height “A” that is generally equal to the height A of the first projection 120. Further, the second projection 122 may have a flat surface or top that has a width “B” generally equal to the width B of the first projection 120. The width B of the projections 120 and 122 may be selected so as to facilitate a tight seal being formed between the projections 120 and 122 and the depressions 138 and 140 when a mold press applies a force to the mold assembly 100 as explained in greater depth below with respect to FIG. 7. If the width B is too large, it may be difficult to achieve this tight seal, and if the width B is too small, the force applied by the mold press to the mold assembly may permanently deform the projections 120 and 122.

FIG. 3 illustrates an exemplary cross-sectional view of the second plate 112 taken along cut line 3-3 of FIG. 1 in accordance with aspects provided herein. FIG. 3 is limited to a portion of the second plate 112 containing the mold surface 134. Although FIG. 3 illustrates just the portion of the second plate 112 containing the mold surface 134, the following disclosure is equally applicable to the portion of the second plate 112 containing the mold surface 136.

As shown in FIG. 3, the first depression 138 may comprise a recess or depression extending from the plate surface 132 into the body of the second plate 112 by a depth “D,” where one wall of the depression is formed in part by the mold surface 134. The depth D of the first depression 138 may be less than the height A of the first projection 120 such that when the second plate 112 is superimposed on the first plate 110 and a force is applied to the mold assembly 100, the first depression 138 rests on top of the first projection 120 and prevents the plate surface 132 from coming into contact with the plate surface 114. In exemplary aspects, the depth D may be between 0.3 mm and 0.5 mm. Continuing, the first depression 138 has a width “E.” In exemplary aspects, the width E may be between 1.0 mm and 3.0 mm, between 1.5 mm and 2.5 mm, and/or between 1.9 mm and 2.1 mm.

The second depression 140 may be offset or spaced apart from the first depression 138 by a distance “C,” which may be generally equal to the distance C between the first projection 120 and the second projection 122 as illustrated in FIG. 2. The second depression 140 may share similar dimensions to that of the first depression 138. For instance it may have a width “E” generally equal to the width E of the first depression 138 and be recessed into the second plate 112 by a depth “D” generally equal to the depth D of the first depression 138.

Continuing with respect to FIG. 3, the vent apertures 142 are depicted in cross-section. As explained earlier, the vent apertures 142 may provide a conduit from the mold space to an exterior surface 310 of the second plate 112. Each of the vent apertures 142 may comprise a first portion 312, a second portion 314, a third portion 316, and a fourth portion 318. The first portion 312 may be the portion of the vent aperture 142 that is in communication with the mold surface 134. The first portion 312 may have a width or diameter “F” and a height “G.” In exemplary aspects, the diameter F may be between 1.5 mm and 0.5 mm, between 1.3 mm and 0.8 mm, and/or between 1.1 mm and 0.9 mm. In exemplary aspects, the height G may be between 2.0 mm and 4.0 mm, between 2.5 mm and 3.5 mm, and or between 2.9 mm and 3.1 mm. The diameter F of the first portion 312 may be kept purposefully small to minimize the size of the “nibs” (i.e., moldable composition that is extruded through the first portion 312 of the vent aperture 142) produced during the molding process. Moreover, the small diameter F of the first portion 312 helps to facilitate removal of the nibs as the second plate 112 is disengaged from the first plate 110. In essence, the small diameter of the first portion 312 “tears away” the nibs as the second plate 112 is disengaged from the first plate 110. Another benefit of the first portion 312 having a small diameter is that the internal pressure of the mold space is maintained during the molding process.

The second portion 314 of the vent aperture 142 may transition the first portion 312 into the third portion 316. As such, it may generally be funnel-shaped. The third portion 316 of the vent aperture 142 generally extends vertically upward for a predetermined distance before opening up into the fourth portion 318 as shown in FIG. 3. The fourth portion 318, in turn, opens onto the plate surface 310. The fourth portion 318 generally has a diameter that is approximately twice that of the diameter of the third portion 316. The configuration of the first, second, third, and fourth portions of the apertures 142 facilitates the easy removal of any excess moldable compound that is forced through the apertures 142 during the molding process. For example, during the molding process, excess moldable compound leaves the mold space via the first portion 312 and may follow a spiraling path upward through the second and third portions 314 and 316 to collect in the fourth portion 318. The large diameter of the fourth portion 318 allows for easy access from the plate surface 310 and easy removal of the excess moldable compound from the first, second, and third portions of the aperture.

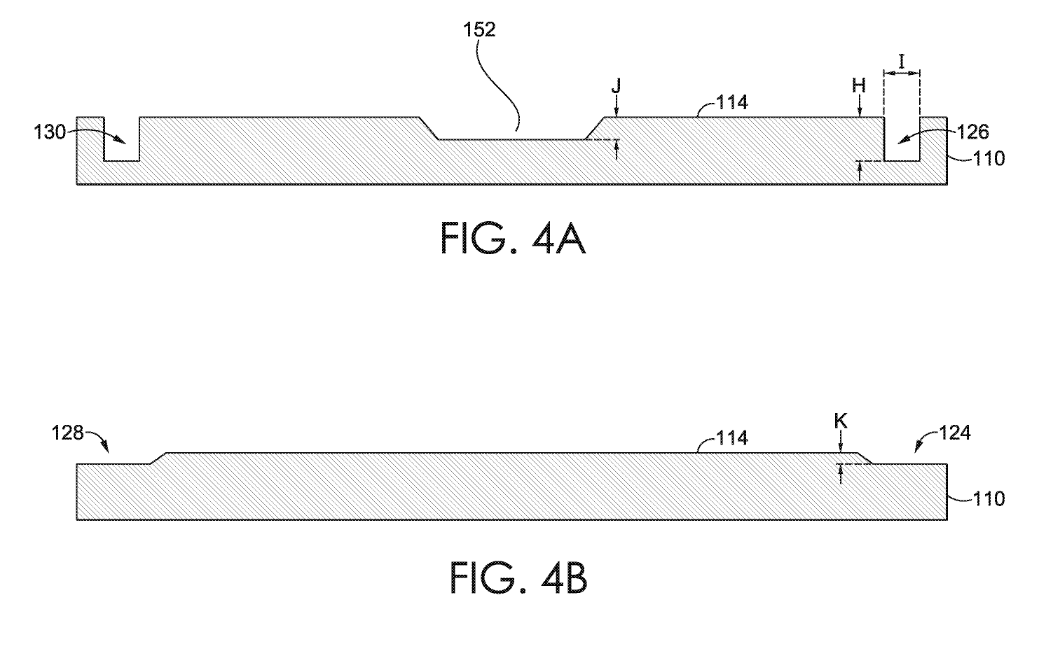

Turning now to FIG. 4A, FIG. 4A illustrates an exemplary cross-sectional view of the first plate 110 taken along cut line 4A-4A of FIG. 1 in accordance with aspects herein. This view illustrates the pin receiving holes 126 and 130 and the midline depression 152. The pin receiving holes 126 and 130 extend generally perpendicularly downward from the plate surface 114 into the body of the first plate 110 by a depth “H.” In exemplary aspects, the depth H may be between 1.5 cm and 2.5 cm, between 1.75 cm and 2.25 cm, and/or between 1.9 cm and 2.1 cm. In exemplary aspects, the pin receiving holes 126 and 130 may generally have a diameter “I” between 0.5 cm and 1.5 cm, between 0.75 cm and 1.25 cm, and/or between 0.9 cm and 1.1 cm. Although the pin receiving holes 126 and 130 are shown as having a circular shape, it is contemplated that the holes may have other shapes such as a square or triangular shape.

The midline depression 152 extends from the plate surface 114 into the body of the first plate 110 by a depth “J.” In exemplary aspects, the depth J may be between 0.3 cm and 1.2 cm, and/or between 0.5 cm and 1.0 cm. As shown in FIG. 4A, the sides of the depression 152 angle inward towards each other to form a beveled edge.

FIG. 4B illustrates an exemplary cross-sectional view of the first plate 110 taken along the cut line 4B-4B in accordance with aspects herein. FIG. 4B depicts the triangular shaped depressions 124 and 128 located at the rear corners of the first plate. The depressions 124 and 128 may extend downward from the plate surface 114 into the body of the first plate 110 by a depth “K.” In exemplary aspects, the depth K may be between 0.3 cm and 1.2 cm, and/or between 0.5 cm and 1.0 cm.

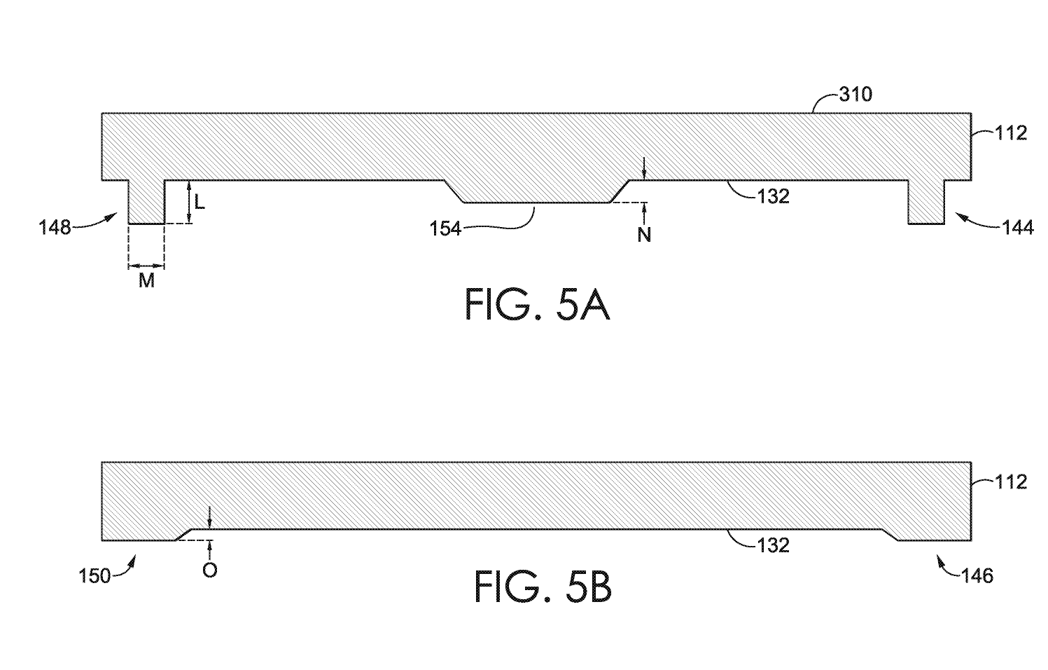

FIG. 5A illustrates an exemplary cross-sectional view of the second plate 112 taken along the cut line 5A-5A in accordance with aspects herein. This view depicts the pins 144 and 148 and the midline projection 154. The pins 144 and 148 extend generally perpendicularly outward from the plate surface 132 a distance “L.” In some exemplary aspects, the distance L may be equal to or less than the depth H of the pin receiving holes 126 and 130 of the first plate 110, while in other exemplary aspects, the distance L may be more than the depth H of the pin receiving holes 126 and 130. The pins 144 and 148 may have a generally circular shape although other shapes are contemplated herein.

The midline projection 154 extends outward from the plate surface 132 by a distance “N.” In exemplary aspects, the distance N may be approximately equal to the depth J of the midline depression 152 of the first plate 110 such that the surface of the projection 154 may contact the bottom of the depression 152 when the first plate 110 is superimposed on the second plate 112. As shown, the sides of the projection 154 angle inward towards each other to form a beveled edge.

FIG. 5B illustrates an exemplary cross-sectional view taken along cut line 5B-5B of FIG. 1 in accordance with aspects herein. FIG. 5B illustrates the two triangular-shaped projections 146 and 150 extending downward from the plate surface 132 by a distance “O.” In exemplary aspects, the distance O may be approximately equal to the depth K of the depressions 124 and 128 of the first plate 110.

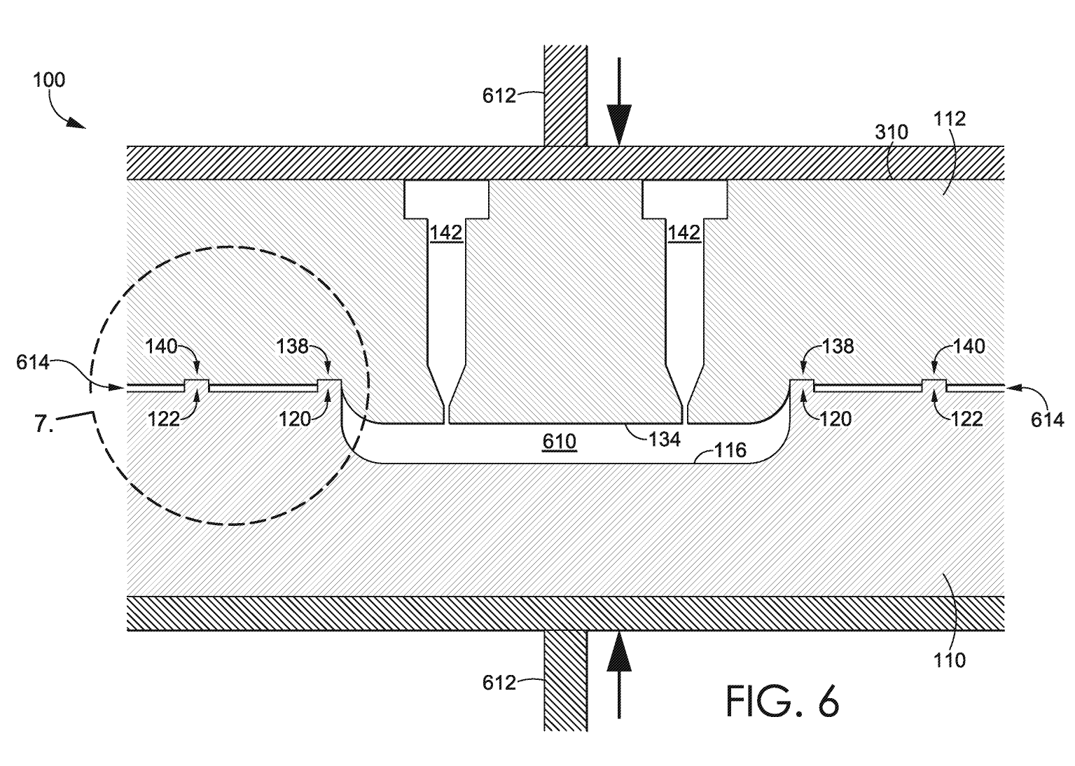

FIG. 6 illustrates an exemplary cross-sectional view of the mold assembly 100 taken generally along cut lines 2-2 and 3-3 of FIG. 1 in accordance with aspects provided herein. The mold assembly 100 is illustrated in an operative configuration. More particularly, FIG. 6 illustrates the second plate 112 superimposed on the first plate 110 and a mold press 612 applying a force to the mold assembly 100 as indicated by the arrows. In exemplary aspects, the mold press 612 may apply force to just the first plate 110 thereby compressing it against the second plate 112, to just the second plate 112 thereby compressing it against the first plate 110, or to both the first plate 110 and the second plate 112 thereby compressing both plates together. Any and all such variations are contemplated as being within the scope herein. As seen, when the second plate 112 is superimposed on the first plate 110, the mold surface 134 of the second plate 112 and the mold cavity 116 of the first plate 110 define a mold space 610 into which a moldable composition comprising, for example, pre-form, pellets, foam, or liquid is filled/injected.

FIG. 6 illustrates the relationship between the projections 120 and 122 and the depressions 138 and 140 when the second plate 112 is superimposed on the first plate 110. The projections 120 and 122 of the first plate 110 may be received into the depressions 138 and 140 of the second plate 112. The area of contact between the projections 120 and 122 and the depressions 138 and 140 may, in an exemplary aspect, comprise the only area of contact between the first plate 110 and the second plate 112 when the mold press 612 is applying force to the mold assembly 100. To put it another way, when the mold press 612 is applying force to the mold assembly 100, the plate surface 114 of the first plate 110 does not come into contact with the plate surface 132 of the second plate 112 leaving a space between the two plates as indicated by the reference numeral 614. The space 614, in exemplary aspects may be between 0.3 mm and 0.7 mm, or between 0.4 mm and 0.6 mm. FIG. 6 further illustrates how the vent apertures 142 are in communication with the mold space 610 when the mold assembly 100 is in an operative configuration.

FIG. 7 illustrates a close-up view of the area indicated on FIG. 6 and is used to illustrate how, in exemplary aspects, the mold assembly 100 may be adapted to prevent flash from forming on the molded article at the intersection of the first plate 110 with the second plate 112. As stated in relation to FIG. 6, when the mold assembly 100 is in an as-used configuration, the mold space 610 is filled and/or injected with a moldable compound and force is applied to the mold assembly 100 by the mold press 612. Unless a tight seal is formed at the intersection between the first projection 120 and the first depression 138, excess moldable compound may move in the direction indicated by arrow 712 of FIG. 7 and potentially exit the mold space 610 at the area indicated by the reference numeral 710 forming flash.

Exemplary aspects described herein allow for a tight seal to be formed between at least the first projection 120 and the first depression 138, which, in turn, prevents moldable compound from exiting the mold space at the intersection of the first plate 110 and the second plate 112. This is because, as previously described, the mold assembly 100 may be configured such that the area of contact between the first plate 110 and the second plate 112 is generally limited to the projections of the first plate 110 and the depressions of the second plate 112. Based on the formula, Pressure=Force/Area, this configuration enables a lesser amount of force to be applied to the mold assembly 100 by the mold press 612 while still generating the amount of pressure needed to cure the moldable compound. In other words, the curing pressure can still be reached even though the force applied to the mold assembly 100 by the mold press 612 is reduced, because the area of contact between the first plate 110 and the second plate 112 is small. This can be contrasted with traditional mold assemblies where the area of contact between the mold plates is much greater because essentially the entire plate surface of one plate (excluding the mold cavity) is in contact with the entire plate surface of the opposing plate when the mold assembly is being used. In this situation, a greater amount of force needs to be applied to the mold assembly by the mold press in order to generate the needed curing pressure.

Continuing, decreasing the force applied to the mold assembly 100 by the mold press 612 enables the second plate 112 to be formed, in total or in part, of softer, more deforming metals such as, for example, bronze, aluminum, and/or alloys of each. Therefore, as long as the force applied by the mold press 612 is below the plastic point of these metals, the depressions 138 and 140 of the second plate 112 will elastically deform to a small degree when they come into contact with the harder metal (e.g., steel) of the projections 120 and 122 of the first plate 120. The result of this elastic deformation is the formation of a tight seal between the projections 120 and 122 and the depressions 138 and 140 and a lack of egress for the moldable compound from the mold space 610 except through the vent apertures 142. More particularly, with respect to FIG. 7, the formation of a tight seal between the projection 120 and the depression 138 “closes off” or occludes the opening 710 effectively trapping the moldable compound in the mold space 610. This may not only eliminate the formation of flash during the molding process but also may help to increase the pressure within the mold space 610 further facilitating the curing process and further decreasing the amount of force that needs to be applied to the mold assembly 100. Moreover, the 90 degree angle of the first projection shown at reference numeral 710 facilitates the formation of a tight seal between the projection 120 and the depression 138 making it harder for the moldable compound to escape the mold space. As another additional factor, besides helping to lessen the amount of force applied to the first projection 120 during the molding process, the second projection 122 acts as another obstacle to any overflow of moldable compound that may occur during molding and further helps to eliminate the formation of flash on the molded article.

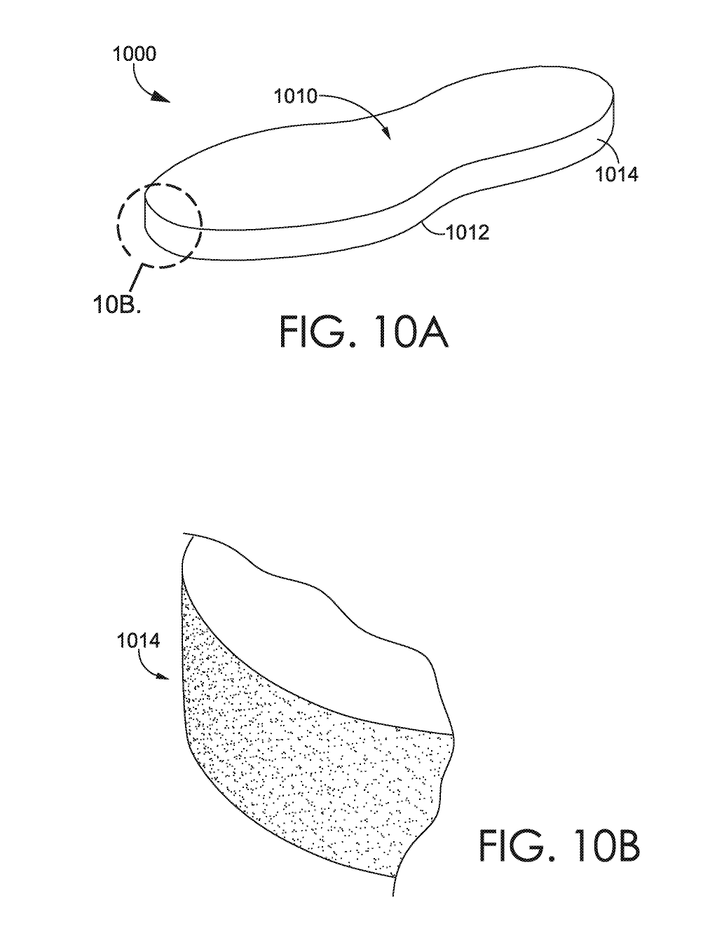

The result of using a mold assembly such as the mold assembly 100 to mold an article of footwear is shown in FIGS. 10A and 10B. FIG. 10A depicts a side perspective view of an article of footwear 1000 molded using the mold assembly 100. The article of footwear 1000 may comprise a midsole, an outsole, or a combination midsole/outsole. The article of footwear 1000 may comprise a top surface 1010, a bottom surface 1012, and a side surface 1014. In exemplary aspects, the top surface 1010 may be substantially adjacent to, for example, the mold surface 134 of the second plate 112 during the molding process, and the bottom surface 1012 may be substantially adjacent to, for example, the mold cavity 116 during the molding process. Alternatively, the top surface 1010 may be substantially adjacent to the mold cavity 116 and the bottom surface 1012 may be substantially adjacent to the mold surface 134 during the molding process. Any and all such aspects, and any variation thereof, are contemplated as being within the aspects discussed herein.

The side surface 1014 of the article 1000 may be adjacent to the intersection of the first plate 110 and the second plate 112 of the mold assembly 100. As explained above with respect to FIG. 7, because of the configuration of the first projection 120 and the first depression 138 flash is prevented from being formed at the intersection of the first and second plates of the mold assembly 100 during the molding process. The result is that the side surface 1014 of the article 1000 comprises a continuous or sealed skin. In other words, the side surface 1014 is generally free of any type of demarcation (e.g., flash) indicating where the first and second plates intersected. This is shown in greater detail in FIG. 10B which illustrates a close-up view of a portion of the side surface 1014 of the article 1000. As seen, the surface 1014 is continuous or sealed without any type of deformation or marking that would indicate where flash may have been formed. This differs from typical mold assemblies that produce flash. In the typical case, a ridge or line would generally indicate where the flashing was removed from the article.

FIG. 8A illustrates the relationship between the corner depressions 124 and 128 of the first plate 110 and the corner projections 146 and 150 of the second plate 112 when the second plate 112 is superimposed on the first plate 110 in accordance with aspects provided herein. As shown, while maintaining the space 614 between the first plate 110 and the second plate 112, the corner projections 146 and 150 of the second plate 112 may be received into the corner depressions 124 and 128 of the first plate 110 when the second plate 112 is superimposed on the first plate 110. The space 614 between the plates 110 and 112 is maintained even as the mold press 612 applies force to the mold assembly 100. In other words, while the mold press 612 applies force to the mold assembly 100, the plate surface 114 of the first plate 110 does not come into contact with the plate surface 132 of the second plate 112.

FIG. 8B illustrates the relationship between the pins 144 and 148 of the second plate 112 and the pin receiving holes 126 and 130 of the first plate 110 when the second plate 112 is superimposed on the first plate 110 in accordance with aspects herein. As well, FIG. 8B illustrates the relationship between the midline projection 154 of the second plate 112 and the midline depression 152 of the first plate 110 when the second plate 112 is superimposed on the first plate 110 in accordance with aspects herein. The alignment of the pins 144 and 148 with the pin receiving holes 126 and 130 along with the alignment of the midline projection 154 with the midline depression 152 helps to secure and align the plates 110/112 during the molding process. Further, with respect to the midline projection 154 and the midline depression 152, the beveled edges of each help to guide the plates 110/112 into proper alignment as the second plate 112 is superimposed on the first plate 110. As shown, the space 614 between the first plate 110 and the second plate 112 is maintained while the mold press 612 applies force to the mold assembly 100.

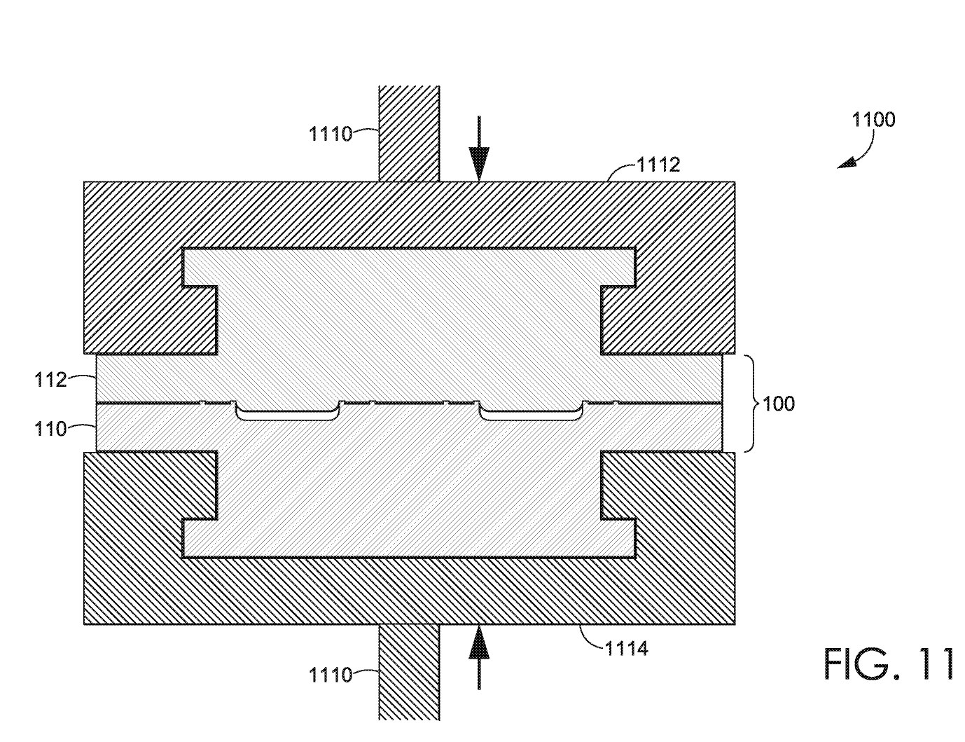

FIGS. 6, 8A and 8B depict one exemplary relationship between a mold press such as the mold press 612 and the plates 110 and 112 of the mold assembly 100. FIG. 11 illustrates another exemplary relationship between a mold press 1110 and the mold assembly 100. FIG. 11 depicts a cross-sectional view of the mold press 1110 and the mold assembly 100 and is provided to illustrate the general relationship between the mold press 1110 and the mold assembly 100. As such, some features of the mold assembly 100 such as, for example, the vent apertures, are not shown. Although not shown, it is contemplated that the mold assembly 100 comprises these features.

As shown in FIG. 11, the mold press 1110 is shaped to form a “drawer” into which the first and second plates 110 and 112 of the mold assembly 100 may be inserted and removed either individually or together. More specifically, the mold press 1110 comprises a top portion 1112 adapted to engage the second plate 112 of the mold assembly 100 and a bottom portion 1114 adapted to engage the first plate 110 of the mold assembly 100. To facilitate the engagement between the plates 110 and 112 and the mold press 1110, the plates 110 and 112 may be shaped differently from the plates 110 and 112 shown in, for example, FIG. 6. The first plate 110 may be inserted into the bottom portion 1114 of the mold press 1110, and the second plate 112 may be inserted into the top portion 1112 of the mold press 1110 in order to mold an article of footwear. Similarly, the plates 110 and 112 may be removed from the mold press 1110 in order to clean the mold assembly 100 and/or to fill the mold assembly 100 with moldable compound.

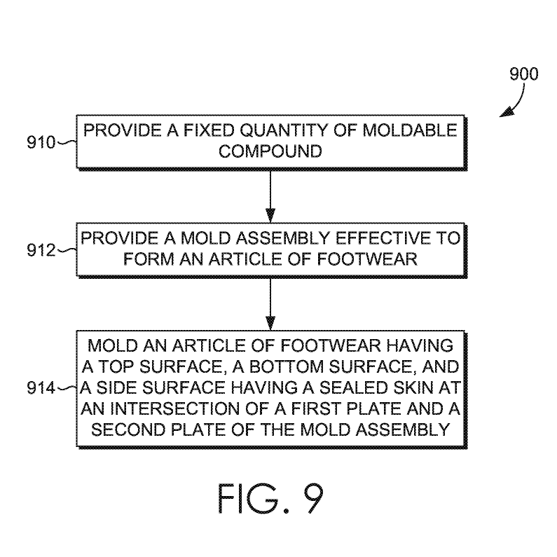

Turning now to FIG. 9, FIG. 9 illustrates a flow diagram of an exemplary method 900 of molding an article of footwear, such as the article of footwear 1000 of FIG. 10A. At a step 910 a fixed quantity of moldable compound is provided. The moldable compound may be in the form of pre-form, pellets, foam, liquid, and the like. At a step 912, a mold assembly effective to form an article of footwear is provided such as the mold assembly 100. At a step 914, the article of footwear is molded from the moldable compound using the mold assembly. The article of footwear may comprise a top surface, a bottom surface, and a side surface. The side surface comprises a continuous or sealed skin at an intersection of a first plate and a second plate of the mold assembly.

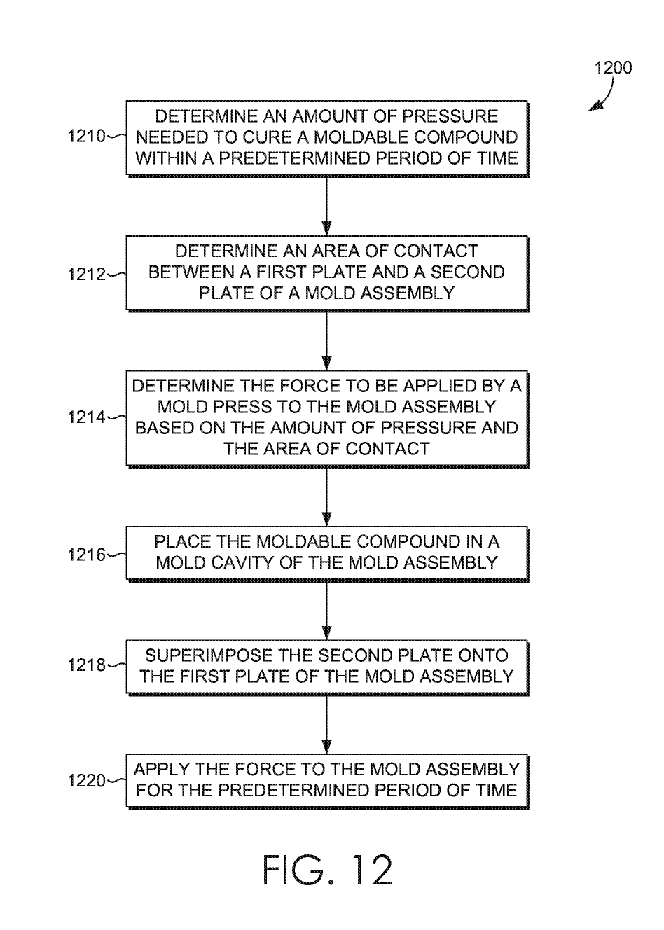

FIG. 12 illustrates a flow diagram of another exemplary method 1200 of molding an article of footwear, such as the article of footwear 1000 of FIG. 10A, using a mold assembly such as the mold assembly 100. At a step 1210, an amount of pressure needed to cure a fixed quantity of moldable compound within a predetermined period of time is determined. The amount of pressure may be further dependent on a temperature within the mold space of the mold assembly. At a step 1212, an area of contact between the first plate and the second plate of the mold assembly is determined. In exemplary aspects, the area of contact between the plates may be limited to the first and second projections 120 and 122 of the first plate 110 and the first and second depressions 138 and 140 of the second plate 112. At a step 1214, a force to be applied to the mold assembly is determined utilizing, for instance, the formula, Force =Pressure x Area, where the pressure is determined at step 1210 and the area of contact is determined at step 1212.

At a step 1216, the fixed quantity of moldable compound may be placed in the mold space(s) formed between the first and second plates of the mold assembly. The moldable compound may, in exemplary aspects, comprise pellets or pre-form that is placed in the mold cavity of the first plate prior to superimposing the second plate on the first plate. In another exemplary aspect, the moldable compound may be injected into the mold space. Any and all such aspects are contemplated as being within the scope herein.

At a step 1218, the second plate may be superimposed on the first plate. Depending on whether the moldable compound is in the form of pellets or pre-form, or whether it is injected into the mold space, the step 1218 may occur before the step 1216. Any and all such aspects are contemplated as being within the scope herein. At a step 1220, the force determined at step 1214 is applied to the mold assembly for the predetermined period of time to form the article of footwear.

Many different arrangements of the various components depicted, as well as components not shown, are possible without departing from the scope of the claims below. Aspects of our technology have been described with the intent to be illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

As used herein and in connection with the claims listed hereinafter, the terminology “any of claims” or similar variations of said terminology is intended to be understood to include any combination of claims, including 2 or more, and so is also understood to include “any one of.”

1. A mold assembly for use in the manufacture of an article of footwear, the mold assembly comprising: a first plate having a plate surface and at least one mold cavity, the first plate having one or more projections extending upward from the plate surface and surrounding the at least one mold cavity, wherein the plate surface surrounds the one or more projections; and a second plate operably coupled to the first plate and adapted to be superimposed on the first plate to define a mold space therein, wherein when the second plate is superimposed on the first plate, the second plate is adapted to primarily contact the one or more projections of the first plate, wherein the mold assembly is effective to mold the article of footwear, the article of footwear comprising at least a top surface, a bottom surface, and a side surface having a continuous skin at the intersection of the first plate and the second plate.

2. The mold assembly of claim 1, wherein the one or more projections completely surround the mold cavity.

3. The mold assembly of claim 1, wherein the one or more projections comprise two projections.

4. The mold assembly of claim 1, wherein the plate surface entirely surrounds the one or more projections of the first plate.

5. The mold assembly of claim 1, wherein the first plate is constructed of a material that deforms to a first degree in response to a fixed force, and wherein the second plate is constructed of a material that deforms to a second degree in response to the fixed force.

6. The mold assembly of claim 5, wherein the first degree of deformation of the first plate is less than the second degree of deformation of the second plate in response to the fixed force.

7. The mold assembly of claim 1, wherein the first plate is constructed of steel.

8. The mold assembly of claim 1, wherein the second plate is constructed of either aluminum or bronze.

9. The mold assembly of claim 1, wherein the second plate further comprises one or more vent apertures in communication with the mold space when the second plate is superimposed on the first plate.

10. The mold assembly of claim 1, wherein the second plate further comprises one or more depressions adapted to receive the one or more projections of the first plate when the second plate is superimposed on the first plate.

11. A molded article of footwear having the following features: a top surface; a bottom surface; and a side surface, the side surface having a continuous skin at an intersection of a first plate and a second plate of a mold assembly.

12. The molded article of footwear of claim 11, wherein the molded article of footwear comprises a midsole.

13. The molded article of footwear of claim 11, wherein the molded article of footwear comprises one of an outsole or a combination midsole/outsole.

14. A method of molding an article of footwear comprising the steps of: providing a fixed quantity of moldable compound; providing a mold assembly effective to form the article of footwear; and molding the article of footwear, the article of footwear having a top surface, a bottom surface, and a side surface having a continuous skin at an intersection of a first plate and a second plate of the mold assembly.

15. The method of molding of claim 14, wherein the first plate of the mold assembly comprises a plate surface and at least one mold cavity, the first plate having one or more projections extending upward from the plate surface and surrounding the at least one mold cavity, wherein the plate surface surrounds the one or more projections; and wherein the second plate is operably coupled to the first plate and is adapted to be superimposed on the first plate to define a mold space therein, wherein when the second plate is superimposed on the first plate, the second plate is adapted to primarily contact the one or more projections of the first plate.

16. The method of molding of claim 15, further comprising: determining an amount of pressure needed to cure the fixed quantity of moldable compound within a predetermined period of time; determining an area of contact between the first plate and the second plate of the mold assembly; and determining a force to be applied by a mold press to the mold assembly based on the amount of pressure needed to cure the fixed quantity of moldable compound and the area of contact between the first plate and the second plate.

17. The method of molding of claim 16, wherein the amount of pressure needed to cure the fixed quantity of moldable compound is further determined based on a temperature within the mold space.

18. The method of molding of claim 14, wherein molding the article of footwear comprises: placing the fixed quantity of moldable compound in the mold cavity of the first plate; superimposing the second plate onto the first plate of the mold assembly; and applying the force to the mold assembly for the predetermined period of time to form the article of footwear.

19. The method of molding of claim 18, wherein placing the fixed quantity of moldable compound in the mold cavity comprises injecting the moldable compound into the mold cavity.

20. The method of molding of claim 18, wherein placing the fixed quantity of moldable compound in the mold cavity comprises placing a pellet form of the fixed quantity of moldable compound in the mold cavity.
